(19) United States
(12) Patent Application Publication
(10) Pub. No.: US 2016/0360146 A1
(43) Pub. Date: Dec. 8, 2016

(54) User-Worn Recording System

(71) Applicant: TASER International, Inc., Scottsdale, AZ (US)

(72) Inventor: Patrick W. Smith, Scottsdale, AZ (US)

(73) Assignee: TASER International, Inc., Scottsdale, AZ (US)

(21) Appl. No.: 14/813,029

(22) Filed: Jul. 29, 2015

Related U.S. Application Data
(60) Provisional application No. 62/169,923, filed on Jun. 2, 2015.

(51) Int. Cl. H04N 5/77; G06F 1/16; H04N 5/225

(52) U.S. Cl. CPC H04N 5/772; H04N 5/2252; G06F 1/163; H04N 2201/02483

(57) ABSTRACT

A body-worn system for capturing visual and audio information. The body-worn system includes a housing having a first end portion and a second end portion. The first end portion has a first opening and the second end portion has a second opening. The housing is formed of a flexible material that retains its shape after being manipulated. A camera is positioned in the housing so that the camera captures visual information through the first opening. A microphone is positioned in the housing so that the microphone captures audio information through the second opening. The housing fits at least partially around a user's neck. The first end portion and the second end portion are manipulated so that first opening and the second opening are oriented toward the field of view of the user while the housing is positioned around the neck of the user.

### FIELD OF INVENTION

Embodiments of the present invention relate to image and/or audio capture devices (e.g., camera, video camera, microphone) that are worn by a user to capture images related to an incident.

### BRIEF DESCRIPTION OF THE DRAWING

Embodiments of the present invention will be described with reference to the drawings, wherein like designations denote like elements, and:

FIG. 1 is a functional diagram of a collar system in accordance with various aspects of the present invention;

FIG. 2 is a functional diagram of another collar system in accordance with various aspects of the present invention;

FIG. 3 is a functional diagram of another collar system in accordance with various aspects of the present invention;

FIG. 4 is a plan view of a collar system according to an implementation of the collar system of FIG. 1;

FIG. 5 is a plan view of the collar system of FIG. 4 positioned on a user;

FIG. 6 is a plan view of a collar system according to an implementation of the collar system of FIG. 2;

FIG. 7 is a plan view of a collar system according to an implementation of the collar system of FIG. 3;

FIG. 8 is a plan view of an implementation of the collar system of FIG. 1 or an implementation of the capture device of the collar systems of FIG. 2 or 3;

FIG. 9 is a plan view of the collar system or capture device of FIG. 8 positioned on a user;

### DETAILED DESCRIPTION OF THE PREFERRED EMBODIMENTS

PCT publication no. WO2009/126432 filed Mar. 24, 2009 with first named inventor Nache D. Shekarri and entitled “Systems and Methods for Incident Recording” is hereby incorporated herein by reference in its entirety so that the disclosure therein may be used for any purpose herein.

A collar system for wearing on (e.g., around) the neck (e.g., collar, shoulders) of a user includes one or more capture devices (e.g., cameras, video cameras, microphones) for capturing images and/or audio information. A collar system may further include a recorder (e.g., digital video recorder, audio recorder) for storing the captured information. A collar system may capture, store, and/or communicate information (e.g., data) that includes video images, still images, audible sounds, geographic position, temperature, and/or other information (e.g., case number, type of incident recorded, witness names, user name, user ID number, description of the geographic location, description of the incident recorded, identification of potential evidence) provided by a user of the collar system. A collar system may annotate captured information with the geographic location where the information was captured and a date stamp (e.g., date, time) of when information was captured. A user may annotate captured information with additional information as discussed above.

A collar system may communicate with other systems. A collar system may communicate with a base station (e.g., vehicle, docking station), centralized station (e.g., computer, server), or a network (e.g., website, cloud-based systems). A collar system may communicate with another system to transfer captured information from the collar system to the other system. The other system may store the information received from the collar system. A user ID (e.g., name, badge number, SSN) and collar system ID number (e.g., serial number) may be communicated with the information sent by the collar system to the other system. All captured and/or recorded information along with any additional information added (e.g., annotated) to the captured information may be transferred to another system.

A collar system may communicate with another system to receive information from the other system. Received information may be used to control the operation of the collar system. Received information may be communicated (e.g., audible, visual) to a user via the user interface (LDC screen, touch screen, speaker) of the collar system. A user may respond to received information (e.g., text, audible, visual). The collar system may capture the user's response. The user's response may be transmitted to another system.

A collar system may be positioned (e.g., partially, completely) around the neck of a user. A collar system may rest and/or be coupled to the collar of the clothing worn by a user. A collar system may rest, at least partially, on the shoulders and/or chest of a user. While the collar system is positioned around the neck of the user, the collar system may remain positioned around the neck and/or on the shoulders or chest of the user to support and/or orient the collar system. To facilitate positioning the collar system around the neck of the user, a housing (e.g., case, container) of the collar system may be partially opened (e.g., U-shaped, parabolic, arc, gooseneck, horseshoe shaped). Portions of the housing of the collar system may be flexible (e.g., bendable, pliant, able to be positioned, moveable) to enable the housing to be shaped for positioning at least partially around the neck of a user. Portions of the housing may be rigid (e.g., inflexible, unbendable, inelastic) to aid positioning the collar system around the neck of the user and orienting the collar system.

The housing of the collar system may be formed of any material or combination of materials suitable to accomplish positioning the collar system around the neck of the user, supporting the housing of the collar system on the user's body, and/or orienting the one or more cameras and/or microphone of the collar system for capturing information. Suitable materials may include metals, plastics, and/or rubbers. An outer surface of a housing of a collar system may be cover partially or wholly with a material that is soft and/or smooth to provide comfort to the user at the locations where the housing contracts the user's neck, body, or tissue.

A collar system may removably couple to the clothing of user. A collar system, includes a housing that may couple to a user's clothing (e.g., shirt, blouse, collar, vest). A fastener may couple the housing of the collar system to the clothing of a user. A fastener may include a magnetic fastener, a hook and loop (e.g., Velcro) fastener, snaps, buttons, loops, zippers, and any other type of conventional fastener. A fastener may retain the collar system positioned around the neck of the user. A fastener may retain the collar system oriented for capture of images and audio information.

A fastener may include two portions that couple to accomplish fastening the collar system to the clothing of a user. One portion of a fastener may be positioned on the clothing and the other portion of the fastener may be positioned on the collar system. The portions of the fastener may engage (e.g., connect, couple) to couple the collar system to the clothing. The portions of the fastener may disengage (e.g., disconnect, decouple) to decouple the collar system from the clothing. A collar system that has been decoupled from the clothing of a user may be removed from around the neck and/or off of the shoulders of the user.

For example, one portion (e.g., female portion) of a snap fastener may be coupled (e.g., sewn) to the clothing of a user. The other portion (e.g., male portion) of the snap fastener may be coupled to the collar system. The portions of the snap may be coupled to couple the collar system to the clothing of the user.

In another example, a magnet of a polarity may be coupled to the clothing of the user. A magnet of the opposite polarity may be coupled to the collar system. The magnets may be brought together so that they are attracted each other and couple to each other thereby coupling the collar system to the clothing of the user. The magnets may be pulled apart to decouple the collar system from the clothing of the user. Various magnets of a proper polarity may be coupled to the clothing of the user to accomplish coupling the collar system to the user.

The portions of a fastener may be positioned on the housing of the collar system and on the clothing of a user so that the housing is oriented with respect to the user so that the collar system may more effectively capture video and audio information that occurs within the field of vision of the user. The fasteners may retain the collar system at the desired orientation while the user moves and performs work.

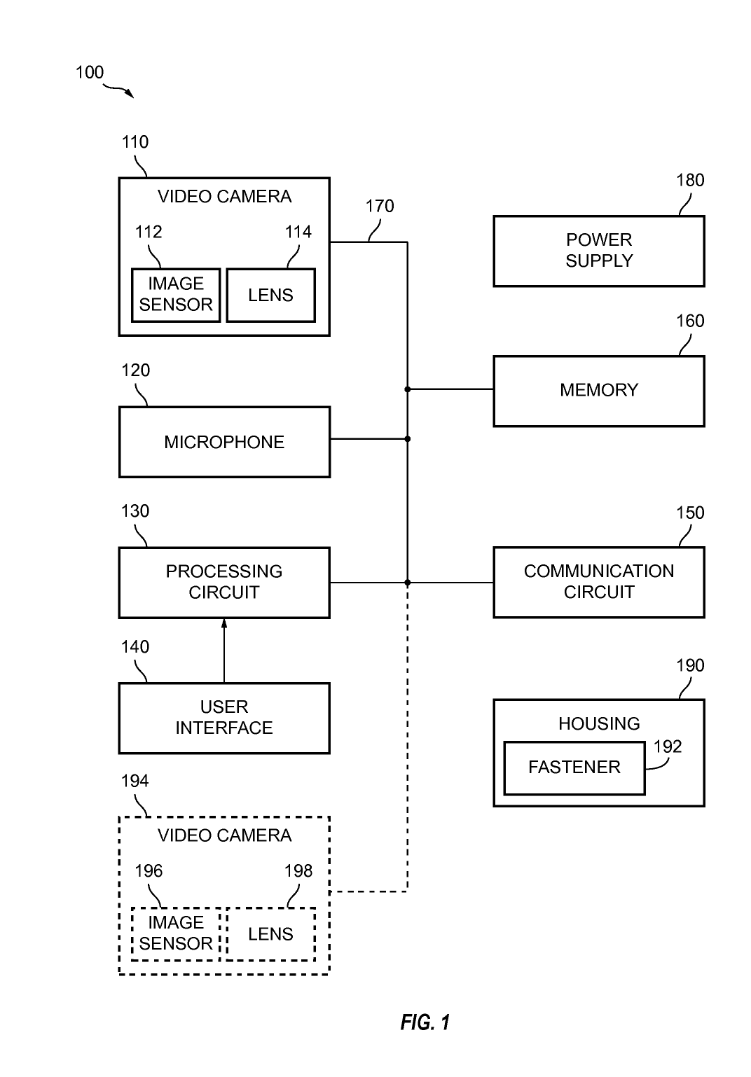

In an implementation, collar system 100 of FIG. 1 includes video camera 110, microphone 120, processing circuit 130, user interface 140, communication circuit 150, memory 160, data bus 170, power supply 180, and housing 190. Video camera 110 includes image sensor 112 and lens 114. Housing 190 includes fastener 192.

In another implementation, collar system 100 of FIG. 1 additionally includes video camera 194, which includes image sensor 196 and lens 198. Video camera 194 performs the functions of a video camera and of video camera 110 as discussed herein. Video camera 194 may be oriented with respect to video camera 110 so that camera 110 and 192 cooperate to capture images in binocular vision.

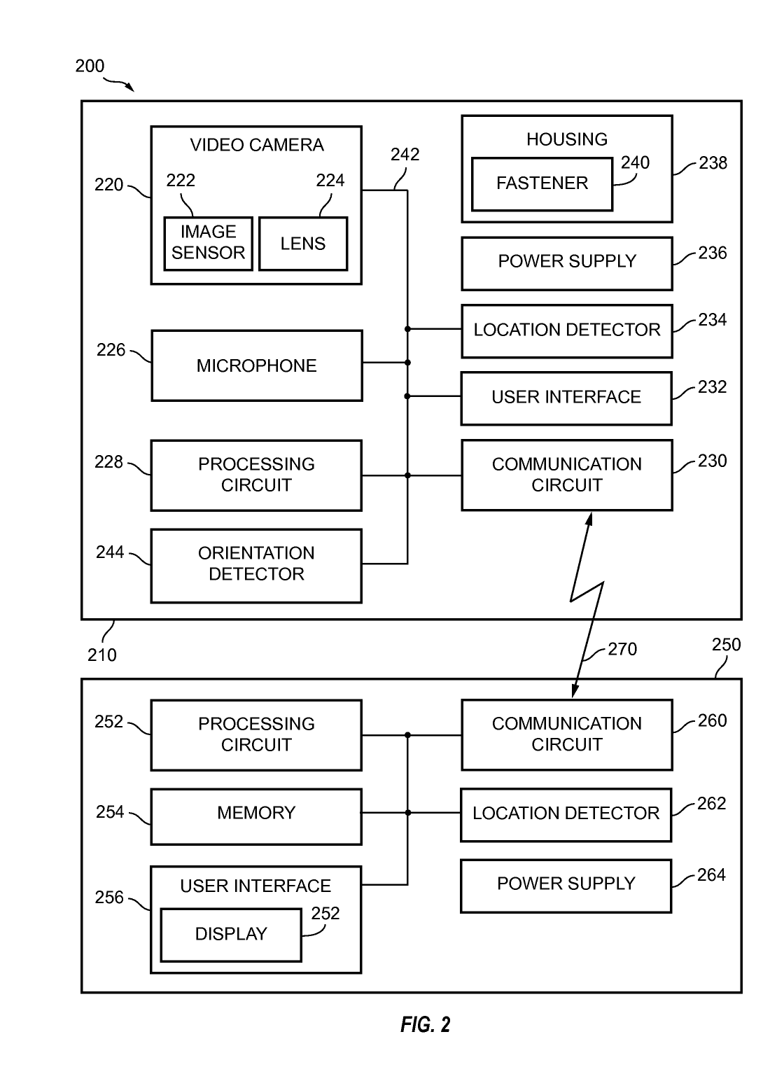

In another implementation, collar system 200 of FIG. 2 includes capture device 210 and recording device 250. Capture device 210 includes video camera 220, microphone 226, processing circuit 228, communication circuit 230, user interface 232, location detector 234, orientation detector 244, power supply 236, housing 238, and data bus 242. Video camera 220 includes image sensor 222 and lens 224. Housing 238 includes fastener 239.

Recording device 250 includes processing circuit 252, memory 254, user interface 256, communication circuit 260, location detector 262, power supply 264, and data bus 266. User interface 256 includes display 258.

Capture device 210 and recording device 250 communicate with each other via wireless communication link 270. Capture device 210 may include a second video camera to provide image capture in binocular vision as discussed above.

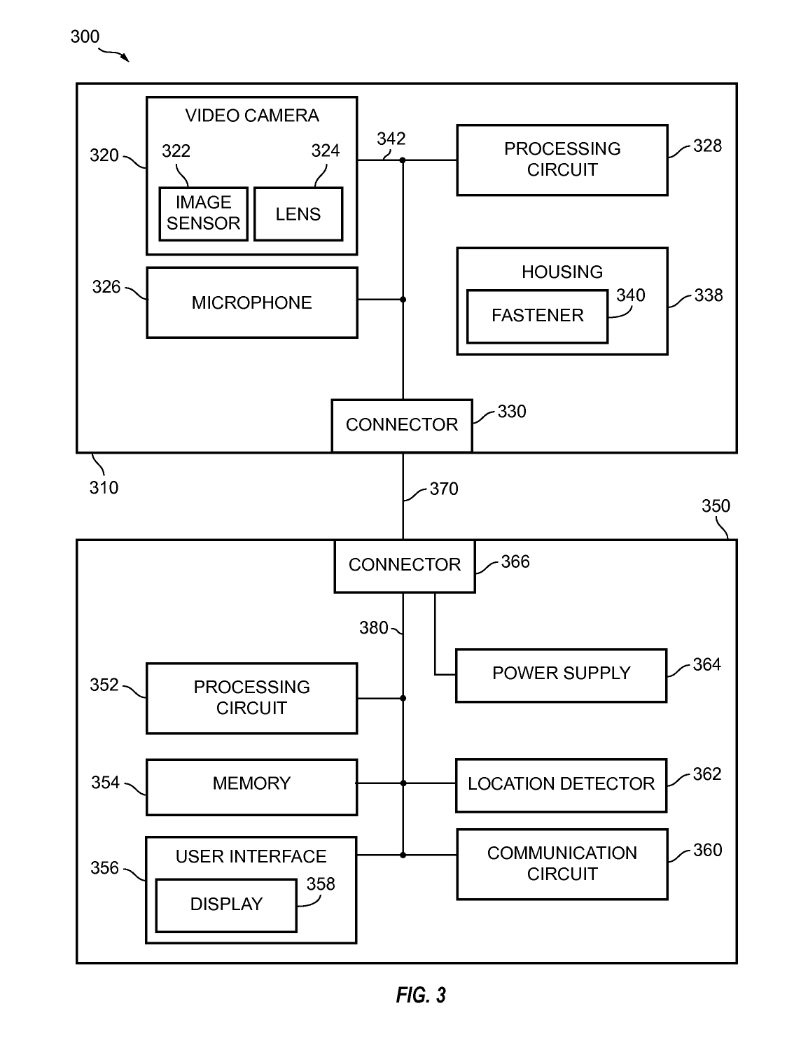

In another implementation, collar system 300 of FIG. 3 includes capture device 310 and recording device 350. Capture device 310 includes video camera 320, microphone 326, processing circuit 328, user interface 332, housing 338, and connector 330. Video camera 320 includes image sensor 322 and lens 324. Housing 338 includes fastener 340. Capture device 310 may further include an orientation detector.

Recording device 350 includes processing circuit 352, memory 354, user interface 356, communication circuit 360, location detector 362, power supply 364, and connector 366. User interface 356 includes display 358.

Capture device 310 and recording device 350 communicate with each other via wired communication link 370. The wire that couples capture device 310 to recording device 350 may couple to capture device 310 and recording device 350 at connectors 330 and 366 respectively. Power supply 364 provides energy to the components of capture device 310 via wired link 370. Capture device 210 may include a second video camera to provide image capture in binocular vision as discussed above.

A video camera captures images (e.g., moving, still). A video camera may capture a single image (e.g., still) or a sequence of images (e.g., moving, video). A video camera may convert captured images into digital information. A video camera may digitally encode captured images using any conventional encoding algorithm. The digital information of a captured image may be stored in a conventional memory in any conventional format. A video camera may include any electrical couplings and/or conventional data bus so that the video camera may provide captured information to another device (e.g., component). Information provided by a video camera via an electrical coupling and/or data bus may be received by another device for further processing (e.g., encoding, noise reduction, facial recognition, color separation, movement detection, storage) of the captured information.

A video camera may include a sensor that detects an image or sequence of images for capture. A sensor may include any conventional device for detecting and/or capturing an image or a sequence of images. A sensor may include a semiconductor device such as charged coupled device (e.g., CCD).

A video camera may include a lens. A lens may include a piece of glass or other transparent material that has two opposite surfaces, either curved or planar, that form an image by focusing rays of light or other form of radiation other than visible light. A lens may be position with respect to a sensor so that the image formed by the lens may be captured by the sensor. A lens may magnify (e.g., enlarge) or decrease the field of view of the camera and thereby the field of view of the image captured by the video camera.

An audio capture device captures audio information (e.g., sounds, voices, speech). An audio capture device may convert captured audio information into a digital format. The digital information from an audio capture device may be stored in a conventional memory in any conventional format. Audio capture devices include microphones. A microphone functions as an acoustic-to-electric transducer to convert sound waves into electrical energy. A microphone may use any conventional techniques for converting sound waves to electrical information such as by electromagnetic induction, capacitance change, or piezo electrical operation. A microphone may be omnidirectional or directional.

Captured audio information may be synchronized with captured images to provide a more complete record of an incident (e.g., occurrence, scene). The relationship between captured audio information and captured images may be stored so that the play back of stored images may be synchronized to stored audio information.

Captured audio and image information may be combined for storage. Any conventional protocol may be used to encode and/or store audio and visual information.

A processing circuit includes any circuitry or subsystem that performs a stored program. A processing circuit may include a dedicated digital signal processor, a microcontroller, a microprocessor, an application specific integrated circuit, logic circuitry, MEMS devices, signal conditioning circuitry, communication circuitry, a conventional computer, a conventional radio, network appliance, and/or a combination thereof in any quantity suitable for executing one or more stored programs.

A processing circuit may further include conventional passive electronic devices (e.g., resistors, capacitors, inductors) and/or active electronic devices (op amps, comparators, analog-to-digital converters, digital-to-analog converters, programmable logic). A processing circuit may include conventional data buses, output ports, input ports, timers, real-time clock, memory, and arithmetic units.

A processing circuit may provide and/or receive electrical signals whether digital and/or analog in form. A processing circuit may provide and/or receive digital information via a conventional bus using any conventional protocol. A processing circuit may receive information, manipulate the received information, and provide the manipulated information to another component. A processing circuit may store information for use in performing the stored program, manipulating data, or performing any operation in accordance with the stored program and received data.

A user interface permits a user to communicate with and/or interact with a collar system. A user interface may include one or more controls that permit a user to interact and/or communicate with the collar system. A user interface may be used by a user to provide instructions (e.g., commands) to a collar system to control (e.g., influence, direct) an operation (e.g., function) of the collar system.

A user interface may receive vocal commands from a user, convert the vocal commands to digital information, and use the digital information to control operation of the collar system.

A control may include any electromechanical device suitable for manual manipulation by a user. A control includes any electromechanical device for operation by a user to establish or break an electrical circuit. A control may include a portion of a touch screen. A control may include a switch. A switch includes a pushbutton switch, a rocker switch, a key switch, a detect switch, a rotary switch, a slide switch, a snap action switch, a tactile switch, a thumbwheel switch, a push wheel switch, a toggle switch, and a key lock switch (e.g., switch lock). Operation of a control may occur by the selection of a portion of a touch screen.

A user interface may further include a communication circuit (e.g., Bluetooth, Bluetooth low energy, wire) for providing notice of the operation of an electromechanical control by a user. Operation of a control may provide a signal to a circuit that includes a communication circuit. Upon detecting the signal from the control, the communication circuit may transmit a notice that reports the operation of the control. A circuit may receive the notice and control operation of the collar system in accordance with the notice. For example, a user may select an icon on the touch screen of a smart phone, the smart phone may detect the selection by the user and send a notice to perform a function in accordance with the notice.

A user interface may receive information that is provided to the user. A user interface may receive information from any component of a collar system for providing information to a user.

Operation of a control of the user interface may result in performance of a function, halting performance of a function, resuming performance of a function, or suspending performance of a function of the collar system.

The term control represents a single electromechanical device for operation by a user to provide information to a collar system. The term controls represents a plurality of electromechanically devices for operation by a user to provide information to a collar system. The term controls include at least a first control and a second control.

A processing circuit may control in whole or in part the operation of a collar system. A collar system may include one or more processing circuits that perform and/or control the same or unrelated functions of the collar system. A processing circuit may perform a function of the collar system responsive to operation of a control. The function performed by the collar system responsive to operation of a control may depend on the current operating state (e.g., present state of operation, present function being performed) of the collar system. For example, if the collar system is presently performing function 1, operating a control may result in the collar system performing function 2. If the collar system is presently performing function 2, operating the control again may result in the device performing function 3 or returning to the performance of function 1.

Functions of a collar system that may be controlled by a user include start capture (e.g., recording), stop capture, playback of captured (e.g., recorded) information, fast forward through captured information, a pause in operation, resume a prior function, delete captured information, initiate transmission of captured information, initiate receipt of information, display received information, and annotate captured information.

Other functions of a collar system that may be performed by a processing circuit include adjusting contrast (e.g., brightness, color, dynamic range) of an image, manipulating the lens to focus an image, performing motion compensation for a sequence of images, encoding images (e.g., MPEG), packaging images for transmission, encrypting information, compressing information, storing information in memory, and retrieving information from memory.

A user may operate the camera of a collar system to capture information to annotate previously captured information. A user may use the microphone of a collar system to capture audio information to annotate previously captured information.

A power supply includes a supply of energy (e.g., power). Energy may be used for enabling the operation of the circuits (e.g., devices) of a collar system. A power supply includes any conventional device for storing and/or providing energy. A power supply may include a battery, a transformer that transforms line power, a capacitor, and/or a coil for transforming (e.g., converting) transmitted electromagnetic waves from a wireless charger (e.g., inductive charging) into electrical energy.

A memory stores information. A memory receives information for storage. A memory provides previously stored information. A memory may provide previously stored information responsive to a request for information. A memory may store information in any conventional format. A memory may store digital information.

A memory includes any semiconductor, magnetic, optical technology, or combination thereof for storing information. A memory may receive information from a processing circuit for storage. A processing circuit may provide a memory a request for previously stored information. Responsive to the request, a memory may provide stored information to the processing circuit.

A memory may store image information, audio information, geographic location information, orientation information, annotation information, and/or any other information associated with, produced by, and/or received by a collar system.

A communication circuit communicates (e.g., transmits, receives) information (e.g., data). A communication circuit may transmit and/or receive information via a wireless link and/or a wired connection. A communication circuit may communicate using wireless (e.g., radio, light, sound, vibrations) and/or wired (e.g., electrical, optical) mediums. A communication circuit may communicate using any wireless (e.g., Bluetooth, Zigbee, WAP, WiFi, NFC, IrDA) and/or wired (e.g., USB, RS-232, Firewire, Ethernet) communication protocols.

A communication circuit may receive information from a processing circuit for transmission. A communication circuit may provide received information to a processing circuit. A processing circuit may store or manipulate (e.g., use) information received from a communication circuit. A communication circuit may provide received information directly to a memory for storage.

A communication circuit in one device (e.g., collar system) may communicate with a communication circuit in another device (e.g., smart phone, recording device). Communications between two devices may permit the two devices to cooperate in performing a function of either device. For example, as discussed above, the user interface for a collar system may be implemented on a smart phone that includes a touch screen. User interaction with the user interface on the smart phone is communicated to the collar system via the communication circuits of the smart phone and collar system. The camera performs the function indicated by the message sent by the user interface on the smart phone via the communication circuits. Any information produced by the collar system for the user may be communicated from the collar system to the smart phone via the communication circuits for display on the display of the smart phone.

A housing encloses (e.g., encases, holds, supports) in whole or part some or all of the components of a collar system. A housing includes structure for mounting (e.g., holding, positioning) the components of a collar system. A housing provides flexible and/or rigid structures for positioning the collar system around the neck of a user. A housing provides flexible and/or rigid structures for positioning the video camera and/or the microphone to capture visual and audio information within the field of view of the user. A housing may include cavities for mounting components of the collar system inside the housing. A housing may have a shape. The shape of a housing may be altered. A housing may be manipulated to have a particular shape. A shape of a housing may be manipulated to be suitable for positioning and retaining around the neck of a user. A shape of a housing may be manipulated to orient the field of view of a video camera and/or a microphone while the collar system is positioned around the neck of a user. In particular, the portion of the housing that holds a video camera and/or a microphone may be positioned independent of the other portions of the housing to orient the video camera and/or microphone toward the point of view of the user. A housing may retain a particular shape after manipulation. A housing may retain a particular shape until altered (e.g., manipulated) to have a different shape.

A housing may include a fastener, or a portion thereof, that fastens to a fastener, or a portion thereof, coupled to the clothing of a user as discussed above. A fastener may retain the housing around a neck of a user. A fastener may retain the position of a video camera and/or a microphone while the collar system is around the neck of a user so that the video camera and the microphone capture video and/or audio information in the field of view of the user.

A display (e.g., monitor, screen) may provide a presentation of information. A display may provide a presentation of visual information (e.g., movie, sequence of images, annotations, metadata). A display may include liquid crystal, semiconductor, or other conventional technology (e.g., LCD, LED, OLED, AMOLED, TFT).

A display that includes a touch screen may further perform the functions of a user interface in that a user may interact with the collar system via interaction with the touch screen. A portion of a touch screen may perform the function of a control of a user interface. A display may present a legend for a control of a user interface. A user may touch a legend presented on a touch screen to operate the control.

A display may further include a speaker to provide audio information (e.g., captured audio, audio annotations) associated with visual information presented on the display.

A collar system may maintain an audit record (e.g., log) that records the operations of the collar system. Each operation detected (e.g., tracked) and logged in an audit record may correspond to an entry. Each entry in an audit record may include a date stamp. Any operation of a collar system may be tracked and result in an audit record entry.

A processing circuit may cooperate with the components of a collar system to detect operations and/or actions for entry into the audit record. A processing circuit may maintain a real-time clock and calendar for generating time stamps.

Operations that may be tracked, detected and monitored in an audit log include: power on, power off, operation of a control, change to the value of the real-time clock used to produce timestamps, geographic location, change in geographic location, orientation of collar system, change in orientation of collar system, user ID (e.g., name, badge number), collar system ID (e.g., serial number), destination of transmitted communications, source of received communications, addition of annotated information, image or video annotated, state of power supply (e.g., energy remaining), power supply ID (e.g., serial number), detected system faults, visual and/or audio information (e.g., file name) presented on a display, establishment of a communication link, and/or loss of a communication link.

An audit record may be stored in a memory. An audit record may be transmitted to another device. An audit record may be protected from being changed by a user.

Collar systems 100/200/300 perform the functions of a collar system discussed above. Video camera 110/220/320, image sensor 112/222/322, lens 114/224/324, microphone 120/226/326, processing circuit 120/228, user interface 140/232/256/332/356, power supply 180/236/264/364, memory 160/254/354, communication circuit 150/230/260/360, housing 190/238/338, location detector 234/262/362, display 258/358, and fastener 192/240/340 perform the functions of a video camera, an image sensor, a lens, a microphone, a processing circuit, a user interface, a power supply, a memory, a communication circuit, a housing, a location detector, a display, and a fastener respectively as discussed above.

In an implementation, the components of collar system 100 are positioned in housing 190 for positioning around the neck of a user. Video camera 110 and microphone 120 are positioned in housing 190 so that lens 114 and image sensor 112 are oriented to capture images and microphone 120 is oriented to capture sounds proximate to the user of collar system 100 and preferably in the field of view of the user. Video camera 110 captures images and microphone 120 captures sounds. The captured images and sounds are converted to digital information, possibly formatted or encoded, for storage in memory 160. Digital information from video camera 110 and microphone 120 is transferred over bus 170 to memory 160. Video camera 110 and microphone 120 may have direct access to memory 160 or data from video camera 110 and microphone 120 may be transferred from video camera 110 and microphone 120 to memory 160 by processing circuit 130.

Video camera 194 may also be positioned in housing 190 and with respect to video camera 110 to provide binocular vision capture.

Communication circuit 150 may be used to transmit information stored in memory 160 to another device. User interface 140 receives information from a user to control the operation of collar system 100. User interface 140 may include a display for presenting information to a user. A display may include LED lights. A user may use video camera 110, microphone 120, and user interface 140 to provide information for annotating captured images and sounds. Annotation information may be stored in memory 160 and communicated via communication circuit 150. Power supply 180 provides energy to sustain the operation of video camera 110, microphone 120, processing circuit 130, user interface 140, memory 160, and communication circuit 150.

Processing circuit 130 may monitor operation of collar system 100. Processing circuit 130 may detect operations of collar system 100. Processing circuit 130 may maintain a real-time clock and may prepare an audit record responsive to monitoring and detecting. Processing circuit 130 may store the audit record in memory 160. Processing circuit 130 may transmit the audit record via communication circuit 150. Processing circuit in cooperation with memory 160 may prevent, under normal operation, a user from modifying, altering, and/or destroying the audit record.

In another implementation, referring to collar system 200 of FIG. 2, the components of capture device 210 are positioned in housing 238 for positioning around the neck of a user. In an implementation, capture device 210 does not store the captured information. Captured information from camera 220 and microphone 226 are transferred to recording device 250 via communication circuits 230 and 260 for storage in memory 254. Recording device 250 is packaged separately from capture device 210. In an implementation, recording device 250 is implemented in a smart phone. In another implementation, recording device 250 is part of an automobile recording system. In another implementation, recording device 250 is part of a system positioned in a central location such as an office. When recording device 250 is part of a system that is immobile, location detector 262 may be omitted.

Captured information from capture device 210 is wirelessly transferred to recording device 250 for storage. Capture device 210 may include some memory for storage, such as buffers or temporary storage, but does not include the memory for storing complete records of an incident. Communication circuit 260 may include more than one circuit or more than one communication link for transferring the information.

Video camera 220 and microphone 226 are positioned in housing 238 so that lens 224 and image sensor 222 are oriented to capture images and microphone 226 is oriented to capture sounds proximate to the user of collar system 200. Video camera 220 captures images and microphone 226 captures sounds. The captured images and sounds are converted to digital information, possibly formatted or encoded, for storage in memory 254. Digital information from video camera 220 and microphone 226 are transferred over bus 242 to communication circuit 230. Communication circuit 230 transmits the captured information to communication circuit 260. The captured information is transferred via bus 266 from communication circuit 260 to memory 254 for storage. Processing circuits 228 and 252 may operate to transfer the information between components of capture device 210 and recording device 250 respectively.

Orientation detector 244 detects the orientation of housing 238. Orientation detector 244 may detect the orientation of video camera 220 and microphone 226. Orientation information may be reported by orientation detector 244 for storing with visual and audio information.

Location detector 234 may detect the geographic location of capture device 210. Geographic information may be reported by location detector 234 for storing with visual and audio information. Geographic information identifies the location where the visual and/or audio information was captured.

User interface 232 permits a user to communicate and/or interact with capture device 210. User interface 232 may permit the user to control the operation of capture device 210 and possible some or all of the functions of recording device 250. In an implementation where recording device 250 is not proximate to a user (e.g., vehicle, office), user interface 232 may include a display for providing information to the user. As discussed above, a display that includes a touch screen may provide controls for interaction of the user with capture device 210. Information provided to a user via user interface 232 may include information from capture device 210 and/or information from recording device 250.

Power supply 236 provides power to components video camera 220, microphone 226, processing circuit 228, location detector 234, user interface 232, and communication circuit 230 so that they may perform their various functions.

As discussed above, recording device 250 receives captured information and other information (e.g., annotations, log) from capture device 210 for storage in memory 254. Stored information or information received in real-time may be presented to a user on display 258 of user interface 256. Stored information may also be transferred from memory 254 to another device, such as a long-term storage device (e.g., server, cloud) via communication circuit 260. Transfer of stored information from memory 254 to another device via communication circuit 260 may be accomplished as the information is received from capture device 210 or after information has been captured for a period of time (e.g., a shift, a day). Communication circuit 260 may include a wired communication link so that accumulated data may be transferred via the wired link when recording device 250 is inserted into a dock for charging.

Memory 254 may be of sufficient capacity to store data captured for a period of time, such as a shift or a day. Memory 254 may be of any type sufficient to provide the storage capacity for the available power.

Processing circuit 252 may include a real-time clock and calendar, as discussed above, to provide time stamps for information received via communication circuit 260, detected by processing circuit 252 (e.g., audit information, geographic information), and/or storage of information in memory 254.

Location detector 262 detects the geographic location of recording device 250. If recording device 250 is an implementation that is carried by the user (e.g., smart phone, separate housing) and is generally in close proximity with capture device 210, location detector 262 may be omitted. If recording device 250 is not carried by the user (e.g., vehicle recording system), location detector 262 may track and reports the geographic position of recording device 250 independent of the geographic location tracked and reported by location detector 234. The geographic location of recording device 250 may be stored in memory 254. Geographic information from location detector 262 may be associated with captured information by correlating timestamps from recording device 250 and capture device 210.

User interface 256 permits a user to communicate with recording device 250 to control the operation of recording device 250 and possible some or all of the functions of capture device 210. Display 258 may display information generated by recording device 250 and/or capture device 210. Display 258 may include a touch screen device that implements one or more controls that enable a user to interact with recording device 250 and/or capture device 210.

Power supply 264 provides power to components processing circuit 252, memory 254, user interface 256, display 258, communication circuit 260, and location detector 262 so that they may perform their functions.

In another implementation, collar system 100 is paired to cooperate with recording device 250. Captured information is stored in memory 160. Annotated information may be stored in memory 160. Audit information for events related to collar system100 is stored in memory 160. Processing circuit 130 may detect events for storage in the audit record stored in memory 160. Audit information for events related to recording device 250 is stored in memory 254. Processing circuit 252 may detect events for storage in the audit record stored in memory 254. A device identifier (e.g., serial number) of recording device 250 may be transferred to collar system 100 for storage in memory 160. A device identifier of collar system 100 may be transferred to recording device 250 for storage in memory 254.

User interface 256 may control the operation of collar system 100 and recording device 250. User interface 140 may be used in parallel with user interface 256, disabled, or omitted from collar system 100 when used with recording device 250. When user interface 256 controls the operation of collar system 100 and recording device 250, audit information related to user interface 256 is stored in memory 254.

Information from memory 160 and memory 254 may be transferred to a central system (e.g., server). Information from memory 160 may be correlated to information from memory 254 using the device identifiers transferred between the units (e.g., 100, 250) and stored in the respective memories. The information from memory 160 and memory 254 may be used to construct a more complete record of the operation of collar system 100 and recording device 250, the cooperation between the devices, the operations performed by the devices, and the interaction of a user with the devices.

In another implementation, referring to collar system 300 of FIG. 3, the components of capture device 310 are positioned in housing 338 for positioning around the neck of a user. In an implementation, capture device 310 does not store captured information or audit information. Captured information from camera 320 and microphone 326 are transferred to recording device 350 via wired link for storage in memory 354. Audit information from capture device 310 is also transferred to recording device 350 for storage.

Connectors 330 and 366 facilitate establishing wired link 370 by providing structure for coupling one or more conductors to (e.g., between) capture device 310 and recording device 350. Wired link 370 may include a wire that has one or more conductors. Wired link 370 may be an extension of data bus 342 to couple with data base 380.

Capture device 310 may include some memory for storage, such as buffers or temporary storage, but does not include the memory for storing complete records of an incident.

Video camera 320 and microphone 326 are positioned in housing 338 so that lens 324 and image sensor 322 are oriented to capture images and microphone 326 is oriented to capture sounds proximate to the user of collar system 300. Video camera 320 captures images and microphone 326 captures sounds. The captured images and sounds are converted to digital information, possibly formatted or encoded, for storage in memory 354. Digital information from video camera 320 and microphone 326 is transferred over bus 342 to wired link 370 to bus 380 to memory 354 for storage. Processing circuits 328 and 352 may operate to transfer the information between components of capture device 210 and recording device 250 respectively. In an implementation, processing circuit 328 may be omitted and processing circuit may control and/or perform the functions of collar system 300.

Location detector 362 detects the geographic location of recording device 350. Because capture device 310 couples to recording device 350 by conductors (e.g., wires), the geographic information of recording device 350 corresponds to the geographic information of capture device 310. Geographic information may be reported by location detector 362 for storing with captured and audit information. Geographic information identifies the location where the visual and/or audio information was captured or the action that resulted in the audit information. The geographic location of recording device 250 may be stored in memory 254.

User interface 356 permits a user to communicate and/or interact with collar device 300. User interface 356 permits the user to control the operation of capture device 310 and recording device 350. As discussed above, a display that includes a touch screen may provide controls for interaction of the user with collar device 300. Information provided to a user via user interface 356 may include information from capture device 310 and/or information from recording device 350.

Power supply 364 provides power to components video camera 320, microphone 326, processing circuit 328, connectors 330/366, if needed, processing circuit 352, memory 354, user interface 356, display 358, location detector 362, and communication circuit 360 so that they may perform their functions.

As discussed above, recording device 350 receives captured information and other information (e.g., annotations, log) from capture device 310 for storage in memory 354. Stored information or information received in real-time may be presented to a user on display 358 of user interface 356. Stored information may also be transferred from memory 354 to another device, such as a long-term storage device (e.g., server, cloud) via communication circuit 360. Transfer of stored information from memory 354 to another device via communication circuit 360 may be accomplished as the information is received from capture device 310 or after information has been captured for a period of time (e.g., a shift, a day). Communication circuit 360 may include a wired communication link so that accumulated data may be transferred via the wired link when recording device 350 is inserted into a dock for charging power supply 364.

Memory 354 may be of sufficient capacity to store data captured, audit, and/or annotated information for a period of time, such as a shift or a day. Memory 354 may be of any type sufficient to provide the storage capacity for the available power.

Processing circuit 352 may include a real-time clock and calendar, as discussed above, to provide time stamps for information received via wired link 370, detected by processing circuit 352 or 328 (e.g., audit information, geographic information, annotation information), and/or storage of information in memory 354.

User interface 356 permits a user to communicate with recording device 350 to control the operation of collar device 300 and to provide information to annotate captured information. Display 358 may display information generated by recording device 350 and/or capture device 310. Display 358 may include a touch screen device that implements one or more controls that enable a user to interact with recording device 350 and/or capture device 310.

In another implementation, collar system 100 is paired to cooperate with recording device 350. Captured information is stored in memory 160. Annotated information may be stored in memory 160. Audit information for events related to collar system100 is stored in memory 160. Processing circuit 130 may detect events for storage in the audit record stored in memory 160. Audit information for events related to recording device 350 is stored in memory 354. Processing circuit 352 may detect events for storage in the audit record stored in memory 354. A device identifier (e.g., serial number) of recording device 350 may be transferred to collar system 100 for storage in memory 160. A device identifier of collar system 100 may be transferred to recording device 350 for storage in memory 354.

User interface 356 may control the operation of collar system 100 and recording device 350. User interface 140 may be used in parallel with user interface 356, disabled, or omitted from collar system 100 when used with recording device 350. When user interface 356 controls the operation of collar system 100 and recording device 350, audit information related to user interface 356 is stored in memory 354.

Information from memory 160 and memory 354 may be transferred to a central system (e.g., server). Information from memory 160 may be correlated to information from memory 354 using the device identifiers transferred between the units (e.g., 100, 350) and stored in the respective memories. The information from memory 160 and memory 354 may be used to construct a more complete record of the operation of collar system 100 and recording device 350, the cooperation between the devices, the operations performed by the devices, and the interaction of a user with the devices.

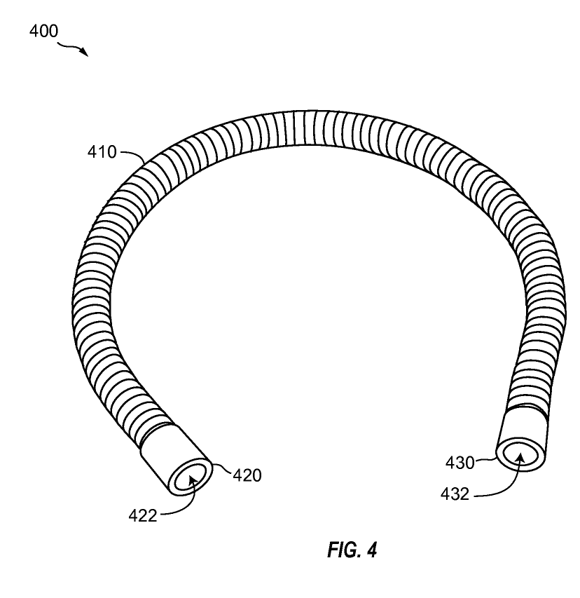

Collar system 400 of FIG. 4 is an implementation of collar system 100. Video camera 320 is positioned at one open end (e.g., extremity) of housing 410 and microphone 430 is positioned at the other open end of housing 410.

Through opening 422 in housing 410, video camera 420 captures image information. A lens of video camera 420 may be aligned with, positioned in, and/or extending through opening 422 in housing 410 so that video camera 420 may capture visual information. Through the other opening, opening 432, in housing 410, microphone 430 captures audio information. The active portion of microphone 430 that detects sound waves may be aligned with, positioned in, and/or extending through opening 432 in housing 410 so that microphone 430 may capture audio information. The other components of collar system 400 may be located (e.g., positioned) inside housing 410. A user interface of collar system 400 may include controls and/or a display that are accessible to a user on an exterior of housing 410.

A second camera may be positioned in the end of housing 410 with video camera 420 to provide image capture with binocular vision as discussed above with respect to video cameras 110 and 194.

Housing 410 is formed of a material that is flexible so that housing 410 may be shaped to fit around the neck of user 510, but housing 410 may also retain its shape so that video camera 420 and microphone 430 may be positioned and oriented to capture information in the field of view or in front of user 510.

Housing 410 may further include one or more fasteners to fasten (e.g., couple) collar system 400 to user 510 in a manner that the orientation of video camera 420 and microphone 430 toward the front of the user are substantially maintained during movement and activity of the user. For example, housing 410 may be formed of a plastic material and may include magnets inside housing 410. Clothing 520 of user 510 may include magnets of opposite polarity to the magnets of housing 410 so that when collar system 400 is placed around the neck of user 510, the magnets of housing 410 magnetically couple to the magnets of clothing 520 to hold collar system 400 in position on user 510 and camera 420 and microphone 430 oriented forward of the user.

In another implementation, housing 410 is formed of a material that is attracted by a magnetic field. Clothes 520 include magnets so that when cameras system 400 is positioned around the neck of user 510, the magnets in clothes 520 coupled to housing 410 to hold collar system 400 in position on user 510.

In another implementation, collar system 400 includes a material that has hooks on the bottom of housing 410 and clothes 520 includes a material that has loops so that the material of housing 410 couples to the material of clothes 520 when collar system 400 is positioned around the neck of user 510 to hold collar system 400 in position on user 510.

In the implementation of collar system 400, housing 410 has the shape of a cylinder (e.g., tube). At least some portions of the interior of the cylinder include cavities for mounting the components of collar system 300. Each end or a portion of each end is open. Camera 420 (or 420 plus another camera for binocular vision) is positioned in one end of the cylinder. The lens of camera 420 extends from the end of the cylinder or light passes through the open end of the cylinder to reach lens of camera 420 on an interior of housing 410.

Microphone 430 is positioned in the other (e.g., opposite) end of the cylinder. A portion of microphone 430 extends out the open end or sound passes through the open end of the cylinder to reach microphone 430 on an interior of housing 410.

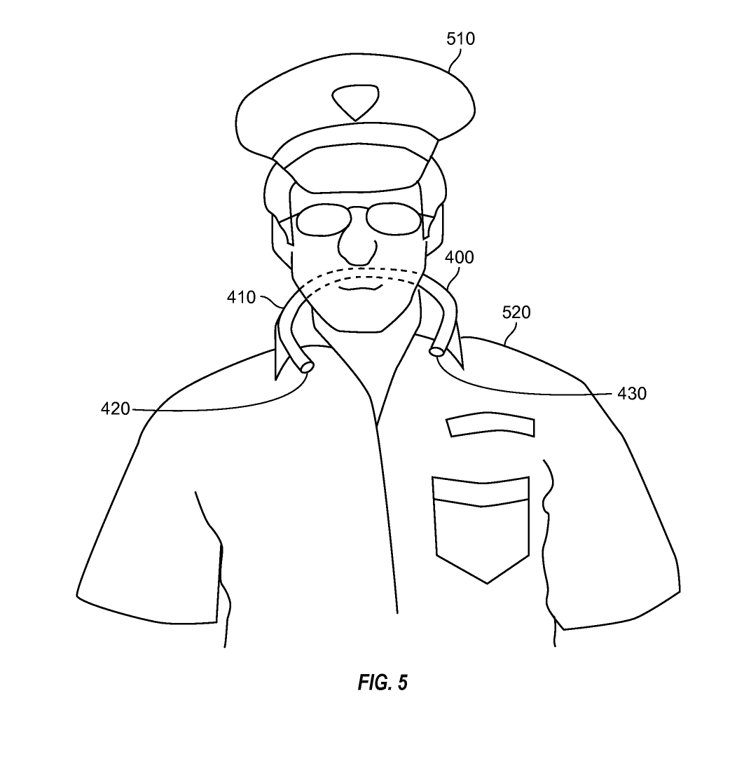

The cylinder may be shaped (e.g., bent, formed) to fit around a user's neck. The shape of the bent cylinder may resemble a “U” shape or the shape of a horse shoe. The ends of housing 410 may be bent out of the plane of the body of housing 410 so that camera 420 and microphone 430 are oriented toward the field of view of the user. In FIG. 5, collar system 400 is show as a planar “U” shape for simplicity of illustrating housing 410 in the neck of user 510. The ends of housing 410 that hold came camera 420 and microphone 430 may be bent (e.g., twisted) upward, with respect to drawing 5, so that the fields of capture of camera 420 and microphone 430 point more along the forward point of view of user 510. Once housing 410 is coupled to clothing 520, the end portions with camera 420 and microphone 430 may be further adjusted to align them with the power of view of user 510. User 510 may review images captured by camera 420 to verify that camera 420 is oriented in the direction of the point of view of user 510.

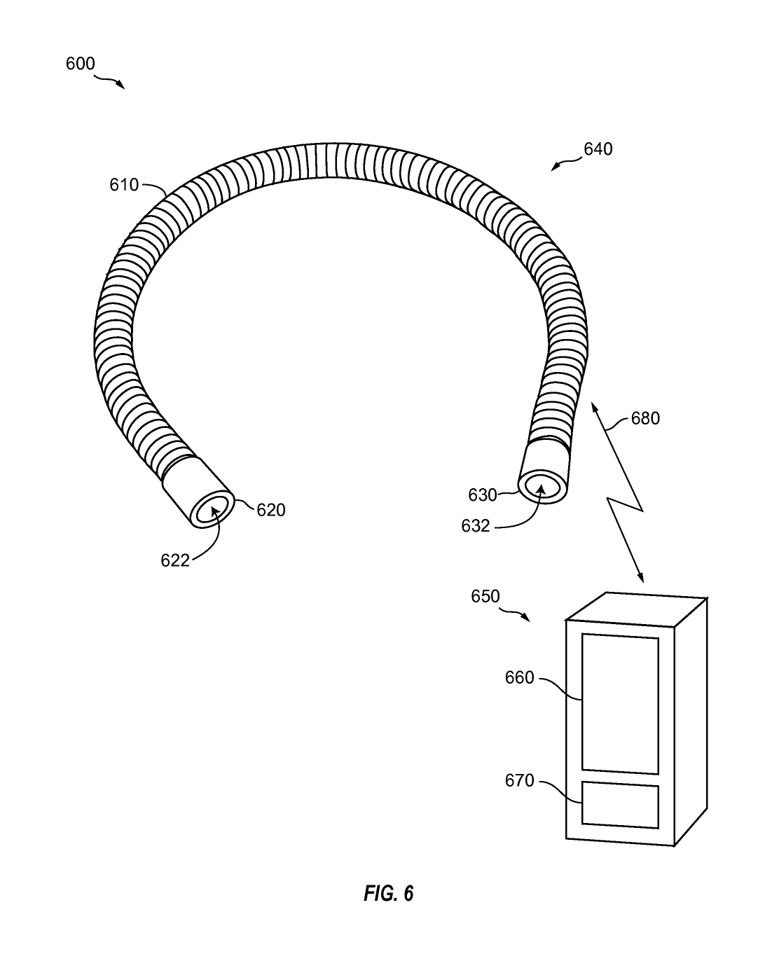

Collar system 600 of FIG. 6 is an implementation of collar system 200 and includes capture device 640 and recording device 650. In another implementation, collar system 400 may replace capture device 640 and cooperate with recording device 650 as discussed below.

In capture device 640, video camera 520 is positioned at one open end of housing 610 and microphone 630 is positioned at the other open end of housing 610 as discussed above with respect to housing 410, camera 420, and microphone 430. Through opening 622 in one end of housing 610, camera 620 captures image information and through the other opening, opening 632, in housing 610, microphone 630 captures audio information. As discussed above with respect to housing 410, housing 610 may have interior cavities for positioning the components of capture system 640 and may be shaped (e.g., bent, positioned) to fit around the neck of a user and to orient camera 620 and microphone 630 toward the point of view of the user. A user interface of capture device 640 may include one or more controls and/or a display that are accessible to a user on an exterior of housing 610.

A second camera may be positioned in the end of housing 610 with video camera 620 to provide image capture with binocular vision as discussed above with respect to video cameras 110 and 194.

Recording device 650 is packaged separately from capture device 640. As discussed above, capture device 650 may be implemented as a smart phone that runs an app that performs the functions of a recording device. Recording device 650 may be carried by user, such as user 510. Recording device 650 includes display 660 and user interface 670. Display 660 may display the information (e.g., captured, audit, annotation) discussed above. A user may interact with user interface 650 to control the operation of recording device 650 and/or capture device 640. Information is transferred between capture device 640 and recording device 650 via wireless communication link 680.

Recording device 650 may be sized so as to fit into the hand of a user so that the user may carry recording device 650 and interact with recording device 650 manually. Recording device 650 may be sized to fit into a pocket of the clothing of a user or on a belt of a user. Recording device 650 may be implemented on a smart phone as discussed above.

Housing 610 performs the functions and has the characteristics of a housing discussed above including housing 410. Housing 610 may include one or more fasteners as discussed with respect to housing 410. Housing 610 may couple to a user and/or the clothing of a user as discussed above with respect to housing 410, user 510, and clothes 520.

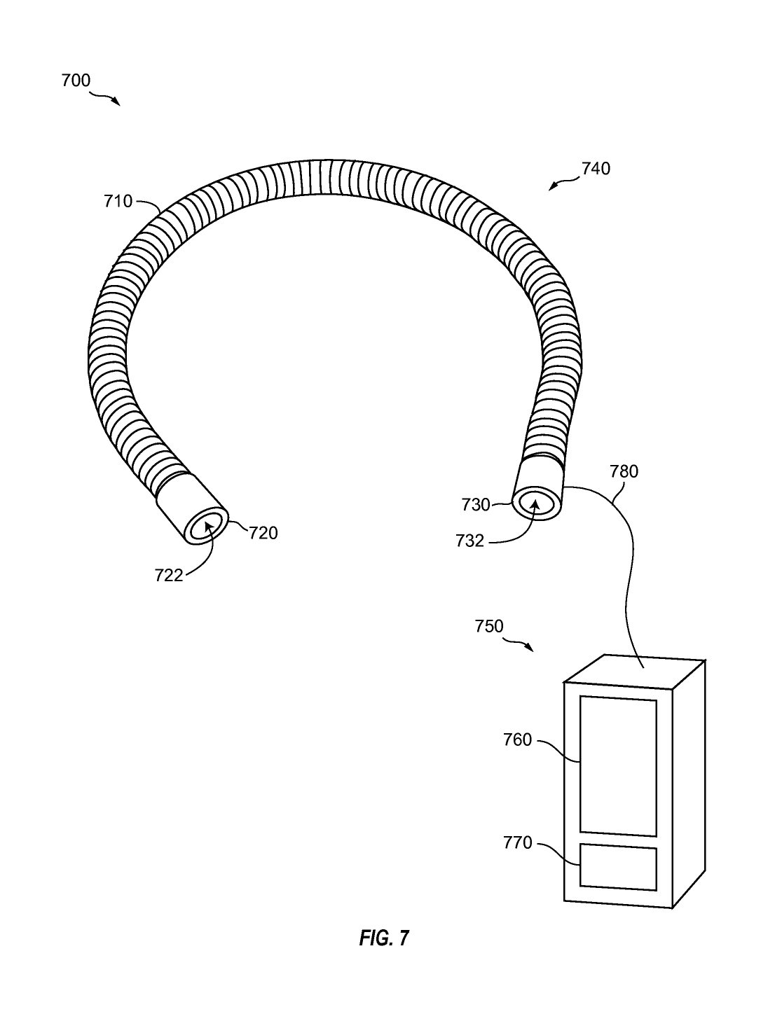

Collar system 700 of FIG. 7 is an implementation of collar system 300 and includes capture device 740 and recording device 750. In another implementation, collar system 400 may replace capture device 740 and cooperate with recording device 750 as discussed below.

In capture device 740, video camera 720 is positioned at one open end of housing 710 and microphone 730 is positioned at the other open end of housing 710 as discussed above with respect to housing 410, camera 420, and microphone 430. Through opening 722 in one end of housing 710, camera 720 captures image information and through the other open end, opening 732, in housing 710, microphone 730 captures audio information. As discussed above with respect to housing 410, housing 710 may have interior cavities for positioning the components of capture system 740 and may be shaped (e.g., bent, positioned) to fit around the neck of a user and to orient camera 720 and microphone 730 toward the point of view of the user.

A second camera may be positioned in the end of housing 710 with video camera 720 to provide image capture with binocular vision as discussed above with respect to video cameras 110 and 194.

Recording device 750 is packaged separately from capture device 740. Recording device 750 may be carried by user, such as user 510. Recording device 750 includes display 760 and user interface 770. Display 760 may display the information (e.g., captured, audit, annotation) discussed above. A user may interact with user interface 750 to control the operation of recording device 750 and/or capture device 740. Information is transferred between capture device 740 and recording device 750 via wired communication link 780.

Recording device 750 may be sized so as to fit into the hand of a user so that the user may carry recording device 750 and interact with recording device 750 manually. Recording device 750 may be sized to fit into a pocket of the clothing of a user or on a belt of a user.

Housing 710 performs the functions and has the characteristics of a housing discussed above including housing 410 and/or 610. Housing 710 may include one or more fasteners as discussed with respect to housing 410. Housing 710 may couple to a user and/or the clothing of a user as discussed above with respect to housing 410, user 510, and clothes 520.

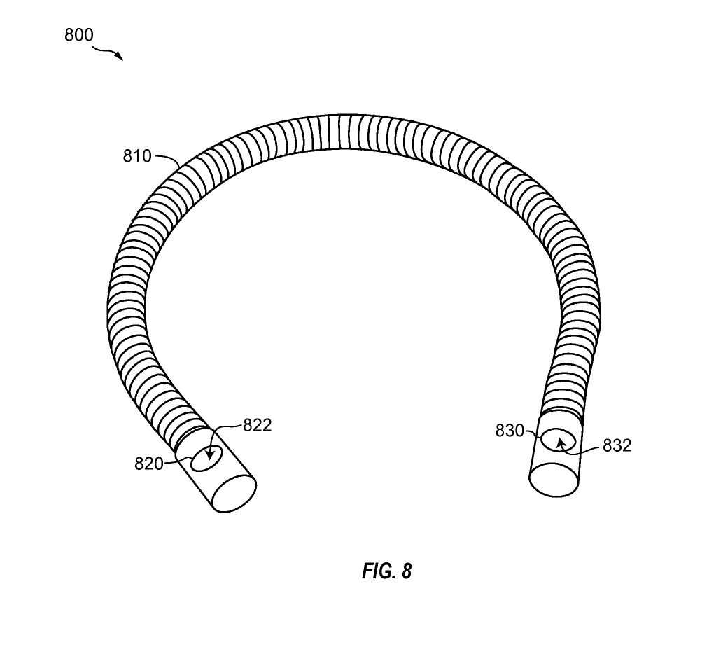

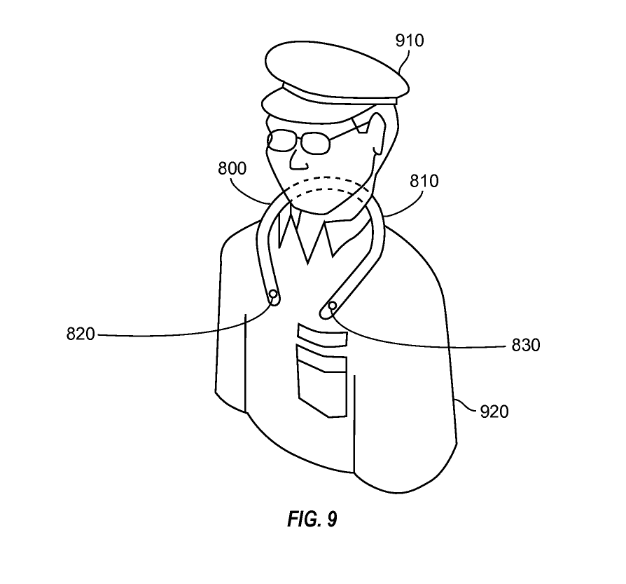

System 800 of FIG. 8 is an implementation of collar system 100, capture device 210, or capture device 310. System 800 performs the functions of collar system 400, capture device 640, or capture device 740. Housing 810 includes openings 822 and 832 on a side of housing 810 toward the ends as opposed to in the extremity (e.g., end, very end) as with housing 410, 610, and 710. Through opening 822 in housing 810, video camera 420 captures image information. A lens of video camera 820 may be aligned with, positioned in, and/or extending through opening 822 in housing 810 so that video camera 820 may capture visual information. Through the other opening, opening 832, in housing 810, microphone 430 captures audio information. The active portion of microphone 430 that detects sound waves may be aligned with, positioned in, and/or extending through opening 832 in housing 810 so that microphone 430 may capture audio information. As with the openings in housings 410, 610, and 710, openings 822 and 832 must be aligned with a user's point of view while housing 810 is worn by the user. Aligning openings 822 and 832 with the user's point of view may require that the extremities of housing 810 must be oriented downward, with respect to FIG. 9, so that the openings 822 and 832 are oriented forward with respect to the user so that camera 820 and microphone 830 can capture images and sound are oriented toward the field of view of user 910 as shown in FIG. 9.

A second camera may be positioned in the end of housing 810 with video camera 820 to provide image capture with binocular vision as discussed above with respect to video cameras 110 and 194.

Housing 810 performs the functions and has the characteristics of housing 310. Housing 810 may include one or more fasteners as discussed with respect to housing 310. Housing 810 may couple to user 910 and/or clothes 920 of user 910 as discussed above with respect to housing 410, user 510, and clothes 520.

The foregoing description discusses preferred embodiments of the present invention, which may be changed or modified without departing from the scope of the present invention as defined in the claims. Examples listed in parentheses may be used in the alternative or in any practical combination. As used in the specification and claims, the words ‘comprising’, ‘including’, and ‘having’ introduce an open ended statement of component structures and/or functions. In the specification and claims, the words ‘a’ and ‘an’ are used as indefinite articles meaning ‘one or more’. When a descriptive phrase includes a series of nouns and/or adjectives, each successive word is intended to modify the entire combination of words preceding it. For example, a black dog house is intended to mean a house for a black dog. While for the sake of clarity of description, several specific embodiments of the invention have been described, the scope of the invention is intended to be measured by the claims as set forth below. In the claims, the term “provided” is used to definitively identify an object that not a claimed element of the invention but an object that performs the function of a workpiece that cooperates with the claimed invention. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

What is claimed is:

1. A body-worn system for capturing visual and audio information, the system comprising:
a housing having a first end portion and a second end portion, a first opening in the housing in the first end portion, a second opening in the housing in the second end portion, the housing formed of a flexible material that retains its shape after manipulation;
a camera, the camera positioned at least partially in the housing so that the camera captures visual information through the first opening;
a microphone, the microphone positioned at least partially in the housing so that the microphone captures audio information through the second opening; and
a fastener coupled to the housing, the fastener for fastening to clothes of a user; wherein:
the housing is manipulated to fit at least partially around the neck of the user;
the first end portion and the second end portion are manipulated so that first opening and the second opening are oriented toward the field of view of the user while the housing is positioned around the neck of the user.

2. The body-worn system of claim 1 wherein the body when extended is substantially cylindrical.

3. The body-worn system of claim 1 wherein:
the first opening is positioned in at least one of an end and an side of the first end portion, and;
the second opening is positioned in at least one of an end and an side of the second end portion.

4. A body-worn system for capturing visual and audio information, the system comprising:
a housing having a substantially cylindrical shape, the housing formed of a material that permits the housing to be manually bent, the housing retains its shape after being bent, a first end portion of the housing includes a first opening, and a second end portion of the housing includes a second opening;
a camera, the camera positioned in the housing so that the camera captures visual information through the first opening;
a microphone, the microphone positioned in the housing so that the microphone captures audio information through the second opening; and
a fastener; wherein:
the housing is bent to form a U-shape for positioning the housing around the back of a user's neck so that first opening and the second opening are positioned toward a field of view of the user; and
the fastener couples the housing to clothing of the user so that the first opening and the second opening remain positioned toward the field of view of the user as the user moves.

5. The body-worn system of claim 4 wherein:
the first opening is positioned in at least one of an end and an side of the first end portion, and;
the second opening is positioned in at least one of an end and an side of the second end portion.

6. A body-worn system for capturing visual and audio information, the system comprising:
a capture device;
a recording device; and
a wired link that electrically couples the capture device to the recording device; wherein:
the capture device comprises a video camera, a microphone, and a first housing;
the recording device comprising a memory, a user interface, and a second housing;
the first housing is separate from the second housing;
the first housing has a substantially cylindrical shape, the first housing is formed of a material that permits the first housing to be manually bent, the first housing retains its shape after being bent, a first end portion of the first housing includes a first opening, and a second end portion of the first housing includes a second opening, the housing is bent to form a U-shape for positioning the housing around the back of a user's neck so that first opening and the second opening are positioned toward a field of view of the user;
the camera is positioned in the first housing so that the camera captures visual information through the first opening;
the microphone is positioned in the first housing so that the microphone captures audio information through the second opening;
the capture device transfers the captured visual and audio information via the wire link to the recording device for storing in the memory; and
the user interface is manually manipulated by the user to control, at least in part, the operation of the capture device and the recording device.

7. The body-worn system of claim 6 wherein:
the first opening is positioned in at least one of an end and an side of the first end portion, and;
the second opening is positioned in at least one of an end and an side of the second end portion.
